(19) United States
(12) Patent Application Publication
(10) Pub. No.: US 2015/0349906 A1
(43) Pub. Date: Dec. 3, 2015

(54) SCALABLE EFFICIENT FRAMING FOR DIGITAL SIGNALS

(71) Applicants: Eric Joseph Christensen, Allen, TX (US); Vatche Sarkis Soualian, Plano, TX (US)

(72) Inventors: Eric Joseph Christensen, Allen, TX (US); Vatche Sarkis Soualian, Plano, TX (US)

(21) Appl. No.: 14/292,237

(22) Filed: May 30, 2014

(51) Int. Cl. H04J 3/06; H04B 10/27; H04L 12/863

(52) U.S. Cl. CPC H04J 3/0608; H04L 47/50; H04B 10/27

(57) ABSTRACT

A system and method for scalable efficient framing for digital signals is disclosed. The method includes determining offsets of framing bits in a serialized data format and determining expected values of the framing bits. The method also includes receiving a data bit, inserting the data bit into a frame-detection shifting circuit configured to operate as a first-in-first-out queue, and selecting a set of bits corresponding to the offsets from the frame-detection shifting circuit. The method further includes comparing the set of bits to the expected values, determining whether the set of bits matches the expected values, and, if the set of bits matches, indicating that a frame was detected. The method additionally includes shifting the frame-detection shifting circuit by one bit position and repeating the receiving, inserting, selecting, comparing, determining, indicating, and shifting.

### BACKGROUND

1. Field of the Disclosure

The present disclosure relates to communications systems and more specifically to scalable efficient framing for digital signals.

2. Description of the Related Art

Telecommunications systems, cable television systems, and data communication networks use communication networks to rapidly exchange large amounts of information between remote points. A communication network may include network elements that route digital signals, including digital data packets and data frames, through the network. Some network elements may include a distributed architecture, wherein packet processing may be distributed among several subsystems of the network element (e.g., line cards).

Some network elements transmit and receive digital data over a serial data line using a time-division multiplexing (“TDM”) scheme. In a TDM scheme, multiple streams of packets are multiplexed onto a single line with the bits corresponding to each stream occupying well-defined positions within a larger “frame.” For example, in digital multiplex communications systems based on the T-carrier standard, a digital voice or data channel may be encoded as a serial bit stream at a rate of 64 kilobits per second (kbps). This basic encoding may be referred to as Digital Signal 0 (“DS0”). A Digital Signal 1 (“DS1”) encoding may be used to multiplex twenty-four DS1 channels on a communications line capable of transmitting at least 1.544 megabits per second (Mbps). A DS1 channel consists of a sequence of 193-bit frames each consisting of one eight-bit byte from each of the twenty-four DS0 channels followed by a single framing bit. DS1 channels may also be multiplexed together on even higher-speed communications lines. For example, a Digital Signal 2 (“D2”) encoding multiplexes four DS1 channels, or ninety-six DS0 channels, along with framing and control bits, on a communications line capable of transmitting at least 6.312 Mbps. A Digital Signal 3 (“DS3”) encoding multiplexes seven DS2 channels, twenty-eight DS1 channels, or 672 DS0 channels, along with framing and control bits, on a communications line capable of transmitting at least 44.736 Mbps. Both DS2 and DS3 encodings interleave the bits of each DS1 multiplexed into the stream. T-carrier signals are typically carried on electrical communication lines.

Communications over optical communication lines are often encoded using the Synchronous Digital Hierarchy (“SDH”), Synchronous Optical Networking (“SONET”), or Optical Transport Network (“OTN”) standards. Because optical lines are capable of significantly higher speeds than electrical communication lines, optical links using any of these standards can carry, in a TDM format, multiple DS3 channels. For example, a Synchronous Transport Module, level 1 (“STM-1”) operates at 155.520 Mbps and can carry the equivalent of three DS3 channels. As with the T-carrier hierarchy, many higher-speed channels are defined, each encoding capable of multiplexing together multiple lower-speed channels.

Some network elements act as switches for digital data, receiving digital data in a highly-multiplexed TDM format on multiple lines and routing parts of each incoming frame to the appropriate outgoing line. Some network elements may also receive and transmit digital signals in more than one encoding format. For example, some network elements may receive DS3 channels and transmit SDH/SONET or OTN channels, or vice versa. Some network elements may receive SDH/SONET or OTN channels, demultiplex those channels into a set of DS3, DS2, or DS1 channels, route each DS3, DS2, or DS1 channel individually to an output line, and re-multiplex the channels routed to each line into an SDH/SONET or OTN channel for transmission on the output line. Network elements performing these functions are referred to as “transmuxes” because they both transcode and multiplex the digital data streams on which they operate.

Because each digital data stream is serial, network elements operating on a TDM stream must be able to detect the alignment of the frame within the digital signal. For this reason, TDM schemes include a set of framing bits with known values at fixed positions in each frame.

### SUMMARY

In accordance with some embodiments of the present disclosure, a network element includes a port configured to couple to a transmission medium and a frame alignment detector communicatively coupled to the port. The frame alignment detector includes a frame-detection shifting circuit configured to receive data bits, insert the data bits into a first-in-first-out (FIFO) queue, and select a set of the data bits corresponding to offsets of framing bits in a serialized data format. The frame detector also includes a framing decoder configured to compare the set of bits to expected values of the framing bits, determine whether the set of bits matches the expected values and, if the set of bits matches the expected values, indicating that a frame was detected.

In accordance with other embodiments of the present disclosure, a method for scalable efficient framing for digital signals includes determining offsets of framing bits in a serialized data format and determining expected values of the framing bits. The method also includes receiving a data bit, inserting the data bit into a frame-detection shifting circuit configured to operate as a first-in-first-out (FIFO) queue, and selecting a set of bits corresponding to the offsets from the frame-detection shifting circuit. The method further includes comparing the set of bits to the expected values, determining whether the set of bits matches the expected values, and, if the set of bits matches, indicating that a frame was detected. The method additionally includes shifting the frame-detection shifting circuit by one bit position and repeating the receiving, inserting, selecting, comparing, determining, indicating, and shifting

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a block diagram of selected elements of an example network, in accordance with some embodiments of the present disclosure;

FIG. 2 illustrates a block diagram of selected elements of an example network element, in accordance with some embodiments of the present disclosure;

FIG. 3 illustrates a block diagram of selected elements of an example frame alignment detector, in accordance with some embodiments of the present disclosure;

FIG. 4 illustrates a block diagram of selected elements of an example frame-detection shifting circuit for a DS3 channel, in accordance with some embodiments of the present disclosure;

FIG. 5 illustrates a block diagram of selected elements of an example parallel frame alignment detector, in accordance with some embodiments of the present disclosure; and

FIG. 6 illustrates a flow chart of selected elements of a method for detecting frame alignment in a serialized digital data stream, in accordance with some embodiments of the present disclosure.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget 12-1 refers to an instance of a widget class, which may be referred to collectively as widgets 12 and any one of which may be referred to generically as a widget 12.

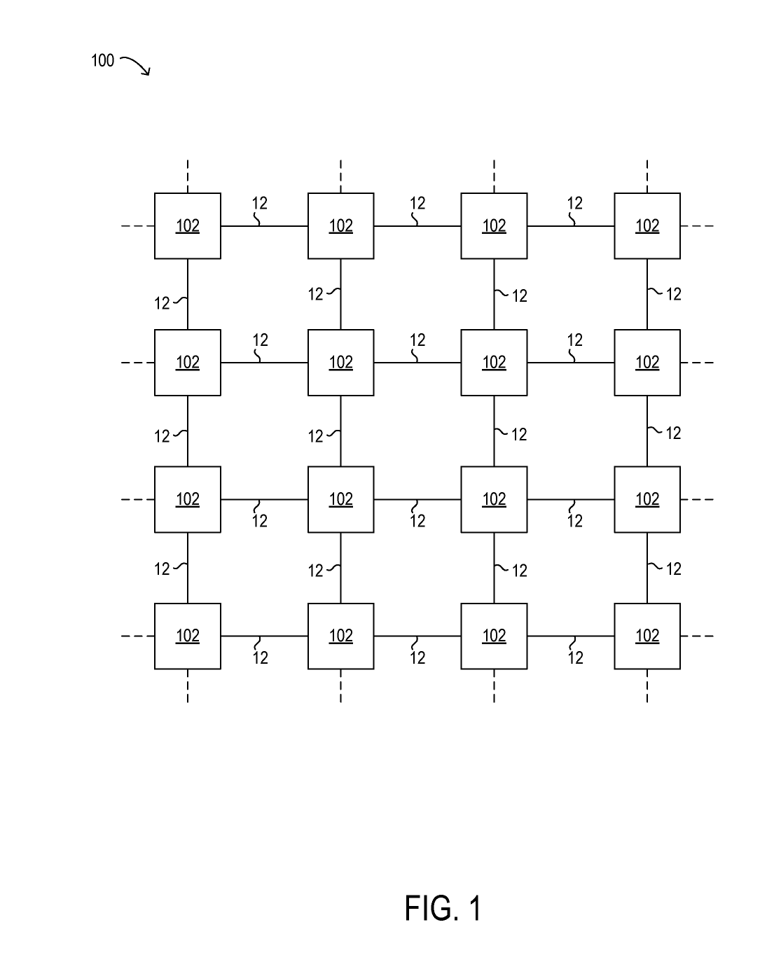

Turning now to the drawings, FIG. 1 illustrates a block diagram of selected elements of example network 100, in accordance with some embodiments of the present disclosure. In certain embodiments, network 100 may be an SDH/SONET network, an OTN network, a T-carrier network, an Ethernet network, a wireless network, or a mixture of these network types. Network 100 may include one or more transmission media 12 operable to transport one or more signals communicated by components of network 100. The components of network 100, coupled together by transmission media 12, may include a plurality of network elements 102. In the illustrated network 100, each network element 102 is coupled to four other nodes. However, any suitable configuration of any suitable number of network elements 102 may create network 10. Although network 100 is shown as a mesh network, network 100 may also be configured as a ring network, a point-to-point network, or any other suitable network or combination of networks. Network 100 may be used in a short-haul metropolitan network, a long-haul inter-city network, or any other suitable network or combination of networks.

Each transmission medium 12 may include any system, device, or apparatus configured to communicatively couple network devices 102 to each other and communicate information between corresponding network devices 102. For example, a transmission medium 12 may include an optical fiber, an Ethernet cable, a T1 cable, a WiFi signal, a Bluetooth signal, or other suitable medium.

Network 100 may communicate information or “traffic” over transmission media 12. As used herein, “traffic” means information transmitted, stored, or sorted in network 100. Such traffic may comprise optical or electrical signals configured to encode audio, video, textual, and/or any other suitable data. The data may also be transmitted in a synchronous or asynchronous manner, and may be transmitted deterministically (also referred to as ‘real-time’) and/or stochastically. Traffic may be communicated via any suitable communications protocol, including, without limitation, the Open Systems Interconnection (OSI) standard and Internet Protocol (IP). Additionally, the traffic communicated via network 100 may be structured in any appropriate manner including, but not limited to, being structured in frames, packets, or an unstructured bit stream.

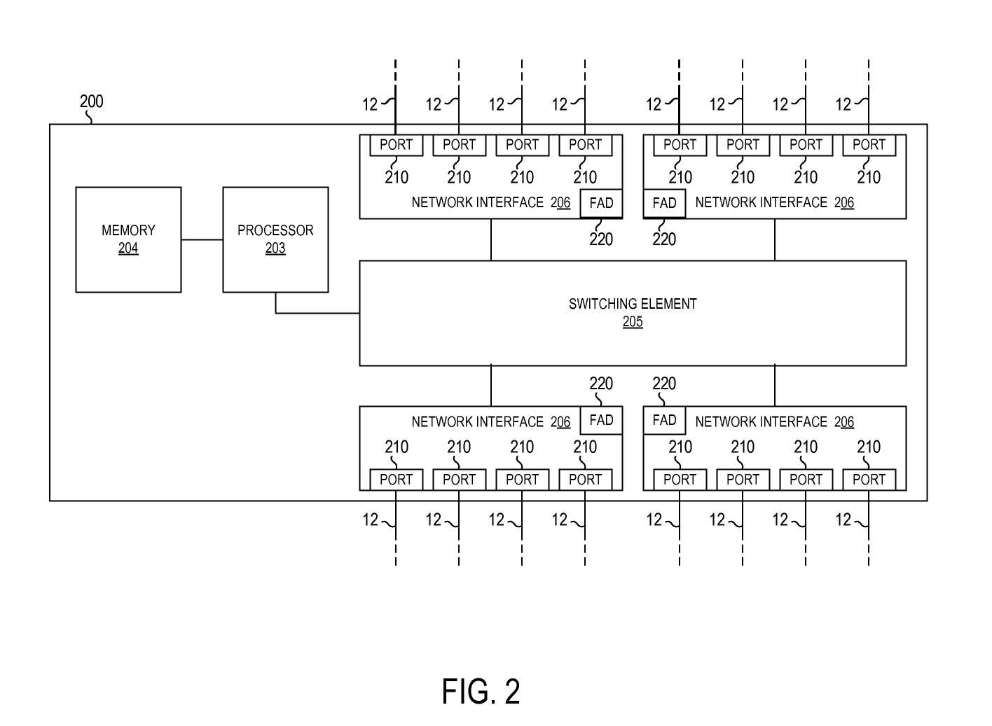

Each network element 102 in network 100 may comprise any suitable system operable to transmit and receive traffic. In the illustrated embodiment, each network element 102 may be operable to transmit traffic directly to one or more other network elements 102 and receive traffic directly from the one or more other network elements 102. Network elements 102 will be discussed in more detail below with respect to FIG. 2.

A component of network 100 and/or a network element 102 may include an interface, logic, memory, and/or other suitable element. An interface receives input, sends output, processes the input and/or output, and/or performs other suitable operations. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to network 100 without departing from the scope of the disclosure. The components and elements of network 100 described may be integrated or separated according to particular needs. Moreover, the operations of network 100 may be performed by more, fewer, or other components.

FIG. 2 illustrates a block diagram of selected elements of an example network element 102, in accordance with embodiments of the present disclosure. As discussed above, each network element 102 may be coupled to one or more other network elements 102 via one or more transmission media 12. In some embodiments, however, not all network elements 102 may be directly coupled as shown in FIG. 2. Each network element 102 may generally be configured to receive data from and/or transmit data to one or more other network elements 102. In certain embodiments, network element 102 may comprise a switch or router configured to transmit data received by network element 102 to another device (e.g., another network element 102) coupled to network element 102.

As depicted in FIG. 2, network element 200 may include a processor 203, a memory 204, a switching element 205, and one or more network interfaces 206 communicatively coupled to switching element 205.

Processor 203 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 203 may interpret and/or execute program instructions and/or process data stored in memory 205 and/or another component of network element 200. Although FIG. 2 depicts processor 203 as independent of other components of network element 200, in some embodiments one or more processors 203 may reside on network interfaces 206 and/or other components of network elements 102. In operation, processor 203 may process and/or interpret traffic received at a port 210. Accordingly, processor 203 may receive traffic from, or transmit traffic to ports 210 and network elements 206 via switching element 205.

Memory 204 may be communicatively coupled to processor 203 and may include any system, device, or apparatus configured to retain program instructions and/or data for a period of time (e.g., computer-readable media). Memory 204 may include random access memory (RAM), electrically erasable programmable read-only memory (EEPROM), a PCMCIA card, flash memory, magnetic storage, opto-magnetic storage, or any suitable selection and/or array of volatile or non-volatile memory that may retain data after power to network element 102 is turned off. Although FIG. 2 depicts memory 204 as independent of other components of network element 200, in some embodiments one or more memories 204 may reside on network interfaces 206 and/or other components of network element 200.

Switching element 205 may include any suitable system, apparatus, or device configured to receive traffic via a port 210 and forward such traffic to a particular network interface 206 and/or port 210 based on analyzing the contents of the datagrams carrying the traffic and/or based on a characteristic of a signal carrying the datagrams (e.g., a wavelength and/or modulation of the signal). For example, in certain embodiments, a switching element 205 may include a switch fabric (SWF).

Each network interface 206 may be communicatively coupled to switching element 205 and may include any suitable system, apparatus, or device configured to serve as an interface between a network element 200 and a transmission medium 12. Each network interface 206 may enable its associated network element 102 to communicate to other network elements 102 using any suitable transmission protocol and/or standard. Network interface 206 and its various components may be implemented using hardware, software, or any combination thereof. For example, in certain embodiments, one or more network interfaces 206 may include a network interface card. In the same or alternative embodiments, one or more network interfaces 206 may include a line card.

As depicted in FIG. 2, each of network interfaces 206 may include one or more physical ports 210. Each physical port 210 may include any system, device or apparatus configured to serve as a physical interface between a corresponding transmission medium 12 and network interface 206. For example, a physical port 210 may comprise an Ethernet port, a BNC connector, an optical port, or any other suitable port.

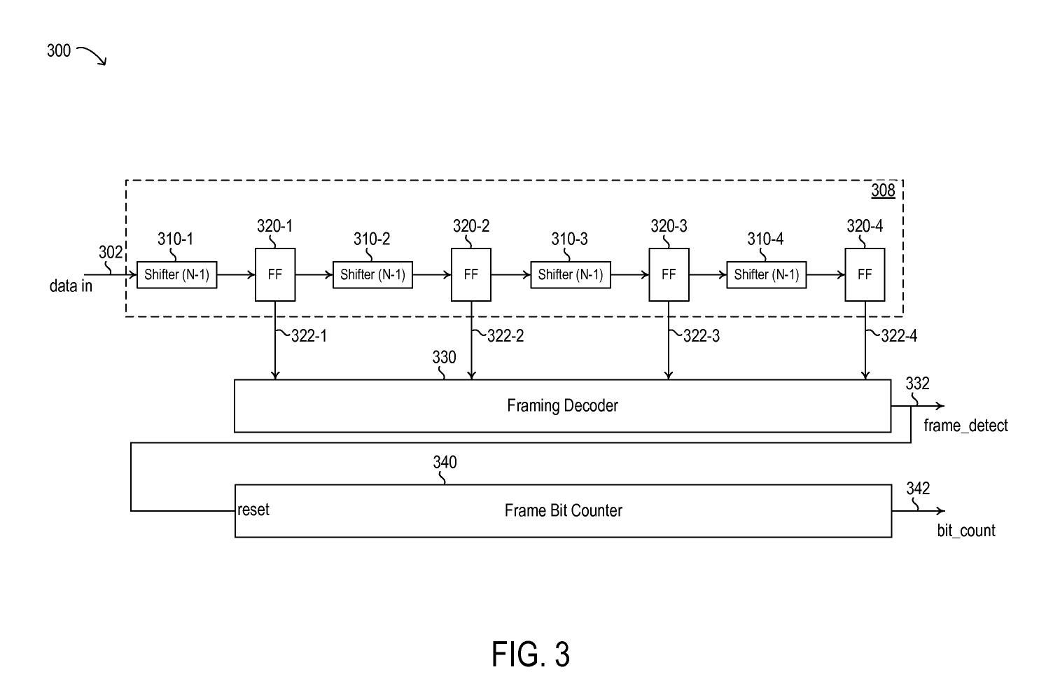

As depicted in FIG. 2, each of network interfaces 206 may include one or more frame alignment detectors 220. Each frame alignment detector 220 may include any system, device or apparatus configured to detect a sequence of framing bits within a digital signal received by network interface 206 via a port 210. For example, frame alignment detector 220 may include one or more state machines, processors, memories, dedicated circuits, or any combination thereof. In some embodiments, frame alignment detector 220 may be implemented on an application-specific integrated circuit (ASIC) or a field-programmable gate array (FPGA). Although FIG. 2 depicts frame alignment detectors 220 as residing on network interfaces 206, in some embodiments frame alignment detectors may reside on other components of network element 200 or may be independent of other components of network element 200. Furthermore, network element 200 may include a single frame alignment detector 220, one frame alignment detector 220 for each network interface 206, one frame alignment detector 220 for each physical port 210, or any other appropriate number of frame alignment detectors. Frame alignment detectors 220 will be discussed in more detail below with respect to FIGS. 3-5.

FIG. 3 illustrates a block diagram of selected elements of an example frame alignment detector 300, in accordance with some embodiments of the present disclosure. Frame alignment detector 300 may be one example of frame alignment detector 220 of network interface 206, discussed with reference to FIG. 2. As depicted in FIG. 3, frame alignment detector 300 may include data input line 302, frame-detection shifting circuit 308, framing decoder 330, and frame bit counter 340. Frame-detection shifting circuit 308 may include an alternating sequence of one or more shifters 310 and one or more flip-flops 320. Example frame alignment detector 300 is configured to detect an example sequence of four framing bits arranged at N-bit intervals in a serialized data stream.

Data input line 302 receives serialized data bits that have arrived at a network interface 206, discussed with reference to FIG. 2. In some embodiments, data input line 302 receives serialized data bits as they are delivered to a port 210, discussed with reference to FIG. 2. In some embodiments, serialized data bits may be stored, for example in a memory, for some period of time between their arrival at network interface 206 and delivery to data input line 302. For example, in the illustrated embodiment, data input line 302 delivers one serialized data bit per clock cycle to shifter 310-1. In alternative embodiments, data input line 302 may deliver serialized data bits to a flip-flop 320.

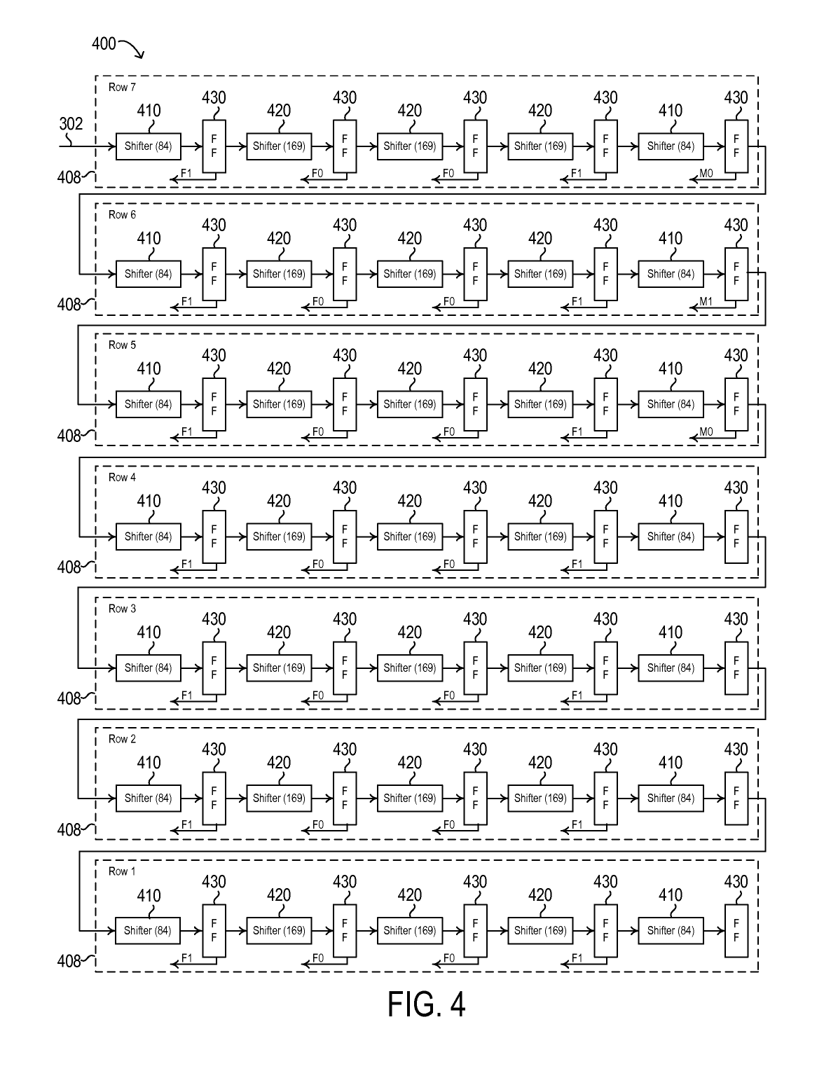

Shifters 310 are circuits configured to operate as a first-in-first-out (FIFO) queue. Each shifter 310 receives one serialized data bit per clock cycle, and presents that serialized data bit at its output a fixed number of clock cycles later. The fixed number of clock cycles may be referred to as the “length” of the shifter, and shifters may be classified according to their length. For example, in the illustrated embodiment, shifter 310-1 is N−1 bits long, and may be referred to as an “(N−1)-bit shifter,” because each serialized data bit presented at the input to shifter 310-1 will be presented at its output N−1 clock cycles later. In the illustrated embodiment, the output of each shifter 310 is connected to the input of a flip-flop 320. In some embodiments, shifters 310 are shift registers implemented on an ASIC or FPGA. In FIG. 3, four shifters 310 are used to correspond to the example sequence of four framing bits arranged at N-bit intervals in the serialized data stream. In some embodiments, a larger or smaller number of shifters 310 may be used. For example, for a serialized data format including thirty-one framing bits, such as the DS3 format discussed below in connection with FIG. 4, thirty-one shifters 310 may be used. In some embodiments, the lengths of shifters 310 will vary, and may be different from one another, to correspond with the intervals between the framing bits in the serialized data stream.

Flip-flops 320 are circuits configured to store a single bit. Each flip-flop 320 receives a one serialized data bit per clock cycle and presents that serialized data bit at its outputs on the next clock cycle. In some embodiments, flip-flops 320 are latches implemented on an ASIC or FPGA. In the illustrated embodiment, each flip-flop 320 has an output 322 connected to framing decoder 330, discussed in more detail below. In the illustrated embodiment, each flip flop 320 with the exception of flip-flop 320-4 has a second output connected to the next shifter 310. Although FIG. 3 depicts flip-flops 320 as independent of shifters 310, in some embodiments flip-flops 320 may be implemented as elements of a shifter 310. Furthermore, in some embodiments, frame-detection shifting circuit 308 may be implemented as a single shift register with internal taps corresponding to outputs 322. In FIG. 3, four flip-flops 320 are used to correspond to the example sequence of four framing bits in the serialized data stream. In some embodiments, a larger or smaller number of flip-flops 320 may be used. For example, for a serialized data format including thirty-one framing bits, such as the DS3 format discussed below in connection with FIG. 4, thirty-one flip-flops 320 may be used.

Framing decoder 330 is a circuit configured to examine outputs 322 to determine if the proper sequence of framing bits is present. As a result of the alternating sequence of shifters 310 and flip-flops 320 in frame-detection shifting circuit 308, outputs 322 correspond to bits at N-bit intervals in the data stream. Thus, framing decoder 330 simply compares each output 322 to the expected sequence of framing bits. If outputs 322 match the expected sequence of framing bits, framing decoder presents a signal indicating a match on frame-detect output 332. If outputs 322 fail to match the expected sequence of framing bits, framing decoder presents a signal indicating no match on frame-detect output 332. For example, if the expected sequence of framing bits (at N-bit intervals in the serialized data stream) were 0-0-1-0, then framing decoder 330 would indicate a match on frame-detect output 332 if and only if outputs 322-1, 322-3, and 322-4 represent zero, and output 322-2 represents one. In some embodiments, framing decoder 330 may detect a match within 50 ms after the first data bit is received at input 302. In some embodiments, framing decoder 330 may be implemented as a logic block on an ASIC or FPGA.

Frame bit counter 340 is a circuit configured to count the number of data bits received since the most recent frame was detected. Frame bit counter 340 maintains an internal counter, whose value it presents on bit-count output 342. Frame bit counter 340 resets its internal counter to zero on any clock cycle in which its reset input is activated. In the illustrated embodiment, the reset input is connected to frame-detect output 332, so the internal counter is reset to zero when a frame is detected. On each clock cycle in which the reset input is not activated, frame bit counter 340 increments its internal counter. In some embodiments, frame bit counter 340 may be implemented as a counter block on an ASIC or FPGA.

FIG. 4 illustrates a block diagram of selected elements of an example frame-detection shifting circuit 400 for a DS3 channel, in accordance with some embodiments of the present disclosure. In embodiments in which the serialized data stream includes DS3 frames, frame alignment detector 300, discussed with reference to FIG. 3, may include frame-detection shifting circuit 400 in place of frame-detection shifting circuit 308. Frame-detection shifting circuit 400 is configured to present outputs of flip-flops 430 that correspond to the intervals between framing bits in a DS3 frame.

The DS3 format, as described above, is used to transport a number of time-division multiplexed lower-level channels such as DS2, DS1, and DS0 channels. A DS3 frame consists of a series of eighty-five bit blocks, each of which starts with a single overhead bit, described in more detail below, followed by eighty-four payload bits that carry the data making up the lower-level channels. Each group of eight consecutive blocks, comprising six hundred and eighty total bits, is known as an “M-frame.” A DS3 frame consists of seven consecutive M-frames, comprising a total of 4760 bits.

The overhead bits in a DS3 frame are divided into “frame alignment bits,” “multi-frame alignment bits,” “parity bits,” “control bits,” and “reserved bits.” Each M-frame contains four frame-alignment bits, as the overhead bits in the second, fourth, sixth, and eighth blocks. The frame alignment bits in the second and eighth blocks of each M-frame are expected to have the value one, and may be referred to as “F1” bits. The frame alignment bits in the fourth and sixth blocks of each M-frame are expected to have the value zero, and may be referred to as “F0” bits. The DS3 frame also has three multi-frame alignment bits, as the overhead bits in the first block of the fifth, sixth, and seventh M-frames. The multi-frame bits in the first blocks of the fifth and seventh M-frames are expected to have the value zero, and may be referred to as “M0” bits. The multi-frame bit in the first block of the sixth M-frame is expected to have the value one, and may be referred to as an “M1” bit. The parity, control, and reserved bits are used for non-framing purposes in the DS3 format, and are outside the scope of this disclosure. The use of the overhead bits in a DS3 frame is summarized in Table 1:

TABLE 1
Overhead bits in a DS3 frame

| | | Block number | | | | | | | |
|---|---|---|---|---|---|---|---|---|---|
| | | 1 | 2 | 3 | 4 | 5 | 6 | 7 | 8 |
| M-Frame number | 1 | X | F1 | C | F0 | C | F0 | C | F1 |
| | 2 | X | F1 | C | F0 | C | F0 | C | F1 |
| | 3 | P | F1 | C | F0 | C | F0 | C | F1 |
| | 4 | P | F1 | C | F0 | C | F0 | C | F1 |
| | 5 | M0 | F1 | C | F0 | C | F0 | C | F1 |
| | 6 | M1 | F1 | C | F0 | C | F0 | C | F1 |
| | 7 | M0 | F1 | C | F0 | C | F0 | C | F1 |

where
F0 = frame alignment bit (expected value 0);
F1 = frame alignment bit (expected value 1);
M0 = multi-frame alignment bit (expected value 0);
M1 = multi-frame alignment bit (expected value 1);
P = parity;
C = control bit; and
X = reserved.

Thus, a DS3 frame will have an overhead bit representing zero in blocks where M0 and F0 bits are indicated in Table 1, and an overhead bit representing one in blocks where M1 and F1 bits are indicated in Table 1. Frame-detection shifting circuit 400, is configured, therefore, to present outputs to a corresponding framing decoder at the appropriate intervals within the data stream to match the M0, M1, F0, and F1 bits in a DS3 frame.

As depicted in FIG. 4, frame-detection shifting circuit 400 may include a sequence of sub-frame shifting circuits 408, each corresponding to a single M-frame in the DS3 frame. Data input line 302 is connected to the input of sub-frame shifting circuit 408-7, corresponding to M-frame 7. The output of each sub-frame shifting circuit 408 is connected to the input of the next sub-frame shifting circuit in the sequence, beginning with M-frame 7 and proceeding in reverse order to M-frame 1.

As depicted in FIG. 4, each sub-frame shifting circuit 408 may include a sequence of 84-bit shifters 410, 169-bit shifters 420, and flip-flops 430. In FIG. 4, the output of each flip-flip 430 that is connected to the framing decoder is labeled with “F0,” “F1,” “M0,” or “M1” to indicate which framing bit is represented on that output when a DS3 frame is properly aligned in frame-detection shifting circuit 400. Thus, the framing detector will indicate that a frame is detected when the F1 and M1 outputs represent the value one, and the F0 and M0 outputs represent the value zero.

In the illustrated embodiment, a serialized data bit traverses each sub-frame shifting circuit 408 in the following order: First, the serialized data bit traverses a first 84-bit shifter 410, then enters a first flip-flop 430 whose output is connected to the framing decoder. Second, the serialized data bit traverses a first 169-bit shifter 420, then enters a second flip-flop 430 whose output is connected to the framing decoder. Third, the serialized data bit traverses a second 169-bit shifter 420, then enters a third flip-flop 430 whose output is connected to the framing decoder. Fourth, the serialized data bit traverses a third 169-bit shifter 420, then enters a fourth flip-flop 430 whose output is connected to the framing decoder. Fifth, the serialized data bit traverses a second 84-bit shifter 410, then enters a fifth flip-flop 430 whose output may be connected to the framing decoder. In the first, second, and third sub-frame shifting circuits 408, corresponding to the seventh, sixth, and fifth M-frames of a DS3 frame, respectively, the output of the fifth flip flop will correspond to an M0 or M1 bit when a frame is properly aligned. Thus, in the first, second and third sub-frame-shifting circuits 408, the output of the fifth flip-flop is connected to the framing decoder. In the remaining sub-frame shifting circuits, the output of the fifth flip-flop may not be connected to the framing decoder. Finally, the serialized data bit exits sub-frame shifting circuit 408 and, in all but the final sub-frame shifting circuit 408, enters the next sub-frame shifting circuit in the sequence.

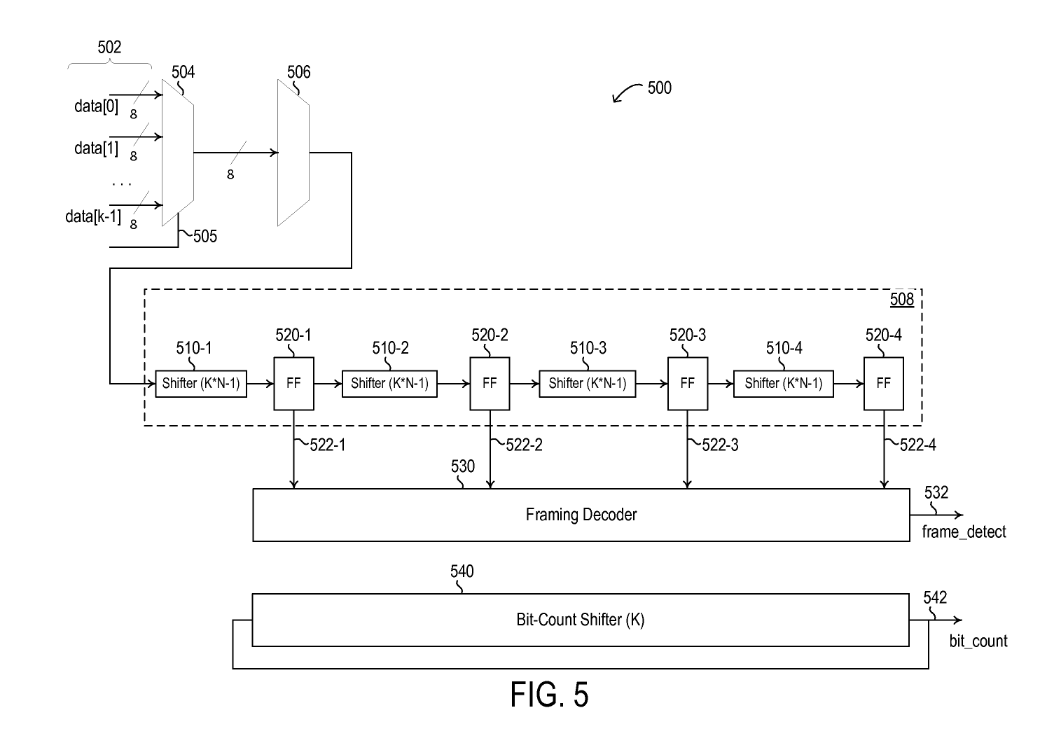

FIG. 5 illustrates a block diagram of selected elements of an example parallel frame alignment detector 500, in accordance with some embodiments of the present disclosure. Parallel frame alignment detector 500 may be used in place of frame alignment detector 300, discussed with reference to FIG. 3, as one example of frame alignment detector 220 of network interface 206, discussed with reference to FIG. 2. As depicted in FIG. 5, parallel frame alignment detector 500 may include data input lines 502, selector 504, multiplexer 506, frame-detection shifting circuit 508, framing decoder 530, and bit-count shifter 540. Example parallel frame alignment detector 500 is configured to detect the framing bits in k different data streams using a single circuit.

Data input lines 502 receive parallel data from k different data streams data[0] through data[k−1]. In the illustrated embodiment, each data stream includes eight 8 bits of data in parallel. In other embodiments, any appropriate number of bits may be provided in parallel. Data input lines 502 are connected to selector 504.

Selector 504 selects the data bits from one of data input lines 502, according to selection input 505, and places them onto its output. In some embodiments election input 505 may cycle through the integers from zero to k−1. As a result, in the illustrated embodiment, selector 504 places eight bits from each of the k data streams onto its output in sequence. The output of selector 504 is connected to multiplexer 506. Multiplexer 506 receives parallel data from a single data stream and serializes the data onto its output. The output of multiplexer 506 is connected to frame-detection shifting circuit 508. In some embodiments, selector 504 and multiplexer 506 may be implemented as logic blocks on an ASIC or FPGA.

Frame-detection shifting circuit 508 is a circuit configured to present outputs 522 that correspond to the intervals between framing bits in a frame within one of the k data streams. For example, in the illustrated embodiment, frame-detection shifting circuit is configured to present outputs 522 that correspond to a sequence of four framing bits arranged at N-bit intervals in one of the k serialized data streams. In the illustrated embodiment, frame-detection shifting circuit 508 includes an alternating sequence of one or more shifters 510 and one or more flip-flops 520. Because the frames in the k multiplexed data streams are multiplexed onto the input of frame-detection shifting circuit 508, each shifter 510 is one less than k times as long as the interval between the corresponding framing bits. For example, in the illustrated embodiment, framing bits are located at intervals of N bits, so each shifter 510 is k*N−1 bits long. In other embodiments, frame-detection shifting circuit 508 may be configured to present outputs 522 corresponding to different intervals within a frame. For example, frame-detection shifting circuit 508 may be configured to present outputs 522 corresponding to the framing bits within a DS3 frame in one of the k multiplexed data streams. In some such embodiments, each shifter 510 is one less than k times as long as the interval between the corresponding framing bits in a DS3 frame. For example, the shifter between a flip-flop corresponding to an F1 bit and the flip-flop corresponding to the adjacent M0 bit in the sixth M-frame of a DS3 frame is k*85−1 bits long. Furthermore, in other embodiments, frame-detection shifting circuit 508 may include only shifters, or only a single shift register with internal taps, as discussed above in connection with frame-detection shifting circuit 308, discussed with reference to FIG. 3. In some embodiments, frame-detection shifting circuit 508 may be implemented as a logic block on an ASIC or FPGA. In FIG. 5, four flip-flops 520 are used to correspond to the example sequence of four framing bits in the serialized data stream. In some embodiments, a larger or smaller number of shifters 510 and flip-flops 520 may be used. For example, for a serialized data format including thirty-one framing bits, such as the DS3 format discussed above in connection with FIG. 4, thirty-one flip-flops 520 may be used. In some embodiments, the lengths of shifters 310 will vary, and may be different from one another, to correspond with the intervals between the framing bits in the serialized data stream. For example, for a serialized data format including thirty-one framing bits, such as the DS3 format discussed above in connection with FIG. 4, a total of thirty-one shifters 510 comprising a mixture of different lengths may be used.

Framing decoder 530 is a circuit configured to examine outputs 522 to determine if the proper sequence of framing bits is present, as discussed above in connection with framing decoder 330, discussed with reference to FIG. 3. Framing decoder 530 presents a signal indicating a match on frame-detect output 532 if and only if outputs 522 match the expected sequence of framing bits. For example, if the expected sequence of framing bits (at N-bit intervals in the serialized data stream) were 0-0-1-0, then framing decoder 530 would indicate a match on frame-detect output 532 if and only if outputs 522-1, 522-3, and 522-4 represent zero, and output 522-2 represents one. In some embodiments, framing decoder 530 may detect a match within 50 ms after the first data bit is received at input 502. In some embodiments, framing decoder 530 may be implemented as a logic block on an ASIC or FPGA.

Bit-count shifter 540 is a circuit configured to count the number of data bits received in each of the k data streams since a frame was detected in that stream. In some embodiments, bit-count shifter 540 maintains a shift register containing k entries. On any clock cycle in which frame-detect output 532 indicates a match, the corresponding entry in the shift register is reset to zero. On any clock cycle in which selection input 505 is changed, the corresponding entry in the shift register is incremented. Bit-count output 542 indicates the value of the counter corresponding to the current one of the k data streams. In some embodiments, bit-count shifter 540 may be implemented as a logic block on an ASIC or FPGA.

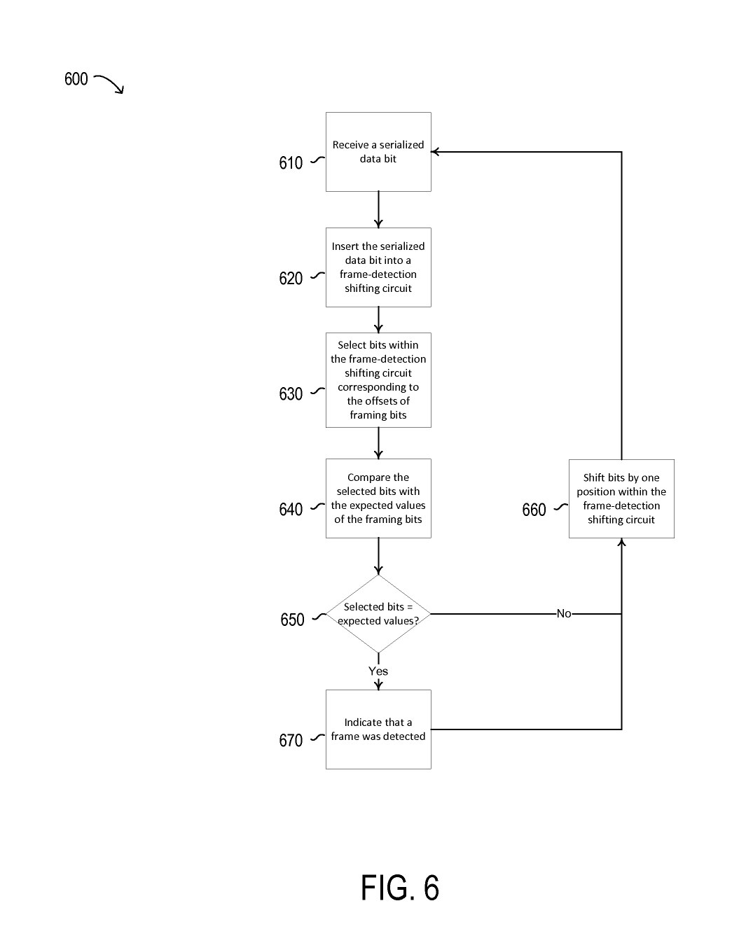

FIG. 6 illustrates a flow chart of selected elements of a method 600 for detecting frame alignment in a serialized digital data stream, in accordance with some embodiments of the present disclosure. For illustrative purposes, method 600 is described with respect to port 210 and frame alignment detector 220 in network element 200, discussed with respect to FIG. 2; however, method 600 may be used to detect frame alignment in any suitable serialized digital data stream. The steps of method 600 can be performed by a user, electronic or optical circuits, various computer programs, models, or any combination thereof, configured to process serialized digital data. The programs and models may include instructions stored on a non-transitory computer-readable medium and operable to perform, when executed, one or more of the steps described below. The computer-readable media can include any system, apparatus, or device configured to store and retrieve programs or instructions such as a hard disk drive, a compact disc, flash memory, or any other suitable device. The programs and models may be configured to direct a processor or other suitable unit to retrieve and execute the instructions from the computer readable media. Collectively, the user, circuits, or computer programs and models used to detect frame alignment in a serialized digital data stream may be referred to as a “frame alignment detector.” For example, the frame alignment detector may be frame alignment detector 220.

Method 600 begins at step 610, the frame alignment detector receives a serialized data bit. For example, input line 302, discussed with reference to FIG. 3, may receive a serialized data bit that arrived at network interface 206, discussed with reference to FIG. 2. As another example, input line 402, discussed with reference to FIG. 4, may receive a serialized data bit that arrived at network interface 206. As another example, one of input lines 502, discussed with reference to FIG. 5, may receive a serialized data bit that arrived at network interface 206. Although specific examples of a serialized data bit are illustrated, any serialized data bit from a suitable serialized data stream may be used.

In step 620, the frame alignment detector inserts the serialized data bit into a frame-detection shifting circuit. For example, the frame alignment detector may insert the serialized data bit into shifter 310 within frame-detection shifting circuit 308, discussed with reference to FIG. 3. As another example, the frame alignment detector may insert the serialized data bit into shifter 410 within frame-detection shifting circuit 408, discussed with reference to FIG. 4. As another example, the frame alignment detector may insert the serialized data bit into shifter 510 within parallel frame-detection shifting circuit 508, discussed with reference to FIG. 5. Although specific examples of frame-detection shifting circuits are illustrated, any suitable frame-detection shifting circuit may be used.

In step 630, the frame alignment detector selects a set of bits within the frame-detection shifting circuit corresponding to the offsets of framing bits. For example, flip-flops 320 within frame-detection shifting circuit 308 may place their stored bits onto outputs 322, discussed with reference to FIG. 3. As another example, flip-flops 420 within frame-detection shifting circuit 400 may place their stored bits onto the M0, M1, F0, and F1 outputs, discussed with reference to FIG. 4. As another example, flip-flops 520 within parallel frame-detection shifting circuit 508 may place their stored bits onto outputs 522, discussed with reference to FIG. 5. Although specific examples of offsets are illustrated, any suitable set of bits corresponding to offsets of framing bits may be used.

In step 640, the frame alignment detector compares the selected bits with the expected values of the framing bits. For example, framing decoder 330 may compare outputs 322 with the expected pattern “0-0-1-0” as discussed above with reference to FIG. 3. As another example, a framing decoder may compare the M0, M1, F0, and F1 outputs of frame-detection shifting circuit 400, discussed with reference to FIG. 4, with the expected pattern of M and F bits shown in Table 1. As another example, framing decoder 530 may compare outputs 522 with the expected pattern “0-0-1-0” as discussed above with reference to FIG. 5. Although specific examples of framing decoders are illustrated, any suitable comparison between the bits selected in step 630 and expected values of framing bits may be used.

In step 650, the frame alignment detector determines whether the selected bits match the expected values. If the selected bits do not match the expected values, the frame alignment detector proceeds to step 660.

In step 660, the frame alignment detector shifts the bits by one position within the frame-detection shifting circuit. For example, frame-detection shifting circuit 308 may shift the contents of shifters 310 and flip-flops 320, discussed with reference to FIG. 3, by one position. As another example, frame-detection shifting circuit 400 may shift the contents of shifters 410 and flip-flops 420, discussed with reference to FIG. 4, by one position. As another example, frame-detection shifting circuit 508 may shift the contents of shifters 510 and flip-flops 520, discussed with reference to FIG. 5, by one position. The frame alignment detector then returns to step 610 to receive the next serialized data bit and begin the next iteration of method 600.

If, however, the selected bits do match the expected values in step 650, the frame alignment detector proceeds to step 670, where the frame alignment detector indicates that a frame was detected. For example, frame decoder 330 may assert frame-detect output 332, discussed with respect to FIG. 3. As another example, frame decoder 530 may assert frame-detect output 532, discussed with respect to FIG. 5. The frame alignment detector then returns to step 660.

Modifications, additions, or omissions may be made to method 600 without departing from the scope of the present disclosure. For example, the steps may be performed in a different order than that described and some steps may be performed at the same time. For example, steps 640 and 650 may be performed simultaneously. Further, more steps may be added or steps may be removed without departing from the scope of the disclosure. Additionally, each individual step may include additional steps without departing from the scope of the present disclosure. For example, step 610 may involve sub-steps of selecting a particular input data stream 502 using a selector 504 and multiplexing its bits using a multiplexer 506, as discussed with reference to FIG. 5.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A network element comprising:
a port configured to couple to a transmission medium and to receive a signal comprising data bits; and
a frame alignment detector comprising:
a frame-detection shifting circuit configured to:
receive the data bits of the signal;
insert the data bits into a first-in-first-out (FIFO) queue; and
select a set of the data bits corresponding to offsets of framing bits in a serialized data format;
a framing decoder communicatively coupled to the frame-detection shifting circuit, the framing decoder configured to:
compare the set of bits to expected values of the framing bits;
determine whether the set of bits matches the expected values; and
if the set of bits matches the expected values, indicating that a frame was detected.

2. The network element of claim 1, wherein the frame-detection shifting circuit comprises:
at least one shifter configured to operate as a FIFO queue; and
at least one flip-flop configured to select the set of data bits corresponding to the offsets.

3. The network element of claim 1, wherein the frame-detection shifting circuit comprises:
a shift register configured to operate as a FIFO queue; and
at least one internal tap of the shift register configured to select the set of data bits corresponding to the offsets.

4. The network element of claim 1, wherein the frame alignment detector further comprises a frame bit counter configured to count the number of data bits received since the most recent frame was detected.

5. The network element of claim 1, the frame alignment detector further comprising:
a selector configured to select data bits from a plurality of input lines; and
a multiplexer coupled communicatively coupled to the selector, the multiplexer configured to serialize the data bits onto a multiplexer output line; and
wherein receiving data bits comprises receiving data bits from the multiplexer output line.

6. The network element of claim 5, wherein the serialized data format is a DS3 format and the offsets are offsets of a DS3 format times the number of input lines in the plurality of input lines.

7. The network element of claim 5, wherein the serialized data format is a SONET/SDH format and the offsets are offsets of a SONET/SDH format times the number of input lines in the plurality of input lines.

8. The network element of claim 5, wherein the serialized data format is an OTN format and the offsets are offsets of an OTN format times the number of input lines in the plurality of input lines.

9. The network element of claim 1, wherein the frame-detection shifting circuit comprises a logic block on an application-specific integrated circuit (ASIC).

10. The network element of claim 1, wherein the frame-detection shifting circuit comprises a logic block on a field-programmable gate array (FPGA).

11. A method for detecting framing bits in a digital data stream comprising:
receiving a data bit;
inserting the data bit into a frame-detection shifting circuit configured to operate as a first-in-first-out (FIFO) queue;
selecting, from the frame-detection shifting circuit. a set of bits corresponding to offsets of framing bits in a serialized data format;
comparing the set of bits to expected values of the framing bits;
determining whether the set of bits matches the expected values;
if the set of bits matches the expected values, indicating that a frame was detected;
shifting the frame-detection shifting circuit by one bit position; and
repeating the receiving, inserting, selecting, comparing, determining, indicating, and shifting.

12. The method of claim 11, wherein the frame-detection shifting circuit comprises:
at least one shifter configured to operate as a FIFO queue; and
at least one flip-flop configured to select the set of data bits corresponding to the offsets.

13. The method of claim 11, wherein the frame-detection shifting circuit comprises:
a shift register configured to operate as a FIFO queue; and
at least one internal tap of the shift register configured to select the set of data bits corresponding to the offsets.

14. The method of claim 11, further comprising counting the number of data bits received since the most recent frame was detected.

15. The method of claim 11, wherein receiving a data bit comprises receiving a data bit from one of a plurality of input lines.

16. The method of claim 11, wherein the serialized data format is a DS3 format and the offsets are offsets of a DS3 format times the number of input lines in the plurality of input lines.

17. The method of claim 11, wherein the serialized data format is a SONET/SDH format and the offsets are offsets of a SONET/SDH format times the number of input lines in the plurality of input lines.

18. The method of claim 11, wherein the serialized data format is an OTN format and the offsets are offsets of an OTN format times the number of input lines in the plurality of input lines.

19. The method of claim 11, wherein the frame-detection shifting circuit comprises a logic block on an application-specific integrated circuit (ASIC).

20. The method of claim 11, wherein the frame-detection shifting circuit comprises a logic block on a field-programmable gate array (FPGA).
